(19) United States
(12) Patent Application Publication
(10) Pub. No.: US 2026/0171385 A1
(43) Pub. Date: Jun. 18, 2026

(54) MANUFACTURING APPARATUS AND MANUFACTURING METHOD OF FIBER-KIND OF ELECTRODE

(71) Applicant: SAMSUNG SDI CO., LTD., Yongin-si (KR)

(72) Inventor: Minho LEE, Yongin-si (KR)

(21) Appl. No.: 19/267,034

(22) Filed: Jul. 11, 2025

(30) Foreign Application Priority Data
Dec. 17, 2024 (KR) 10-2024-0189081

(51) Int. Cl. H01M 4/04; B05C 3/12; B05D 1/18; H01M 4/02; H01M 4/75

(52) U.S. Cl. CPC H01M 4/0404; B05C 3/125; B05D 1/18; H01M 4/75; B05D 2256/00; H01M 2004/027; H01M 2004/028

(57) ABSTRACT

A manufacturing apparatus of a fiber-kind of electrode, including: a tank containing an active material solution and a polymer solution separated into a lower layer and an upper layer, and not mixed with each other; a transport portion configured to transport a fibrous substrate including: a supply roll located outside the tank; a take-up roll installed inside the tank to be immersed in the active material solution; and a winding roll located outside of the tank; a tubular portion surrounding around a part of the fibrous substrate transported between the supply roll and the take-up roll, and installed inside the tank to have an outer surface in contact with the polymer solution; and a dryer installed between the tank and the winding roll, and to dry the fibrous substrate discharged from the tank.

### CROSS-REFERENCE TO RELATED APPLICATION

The present application claims priority to and the benefit of Korean Patent Application No. 10-2024-0189081, filed on Dec. 17, 2024, in the Korean Intellectual Property Office, the entire disclosure of which is incorporated by reference herein.

### BACKGROUND

### 1. Field

Aspects of embodiments of the present disclosure relate to an apparatus for manufacturing an electrode of a fiber-kind of rechargeable battery, and a method for manufacturing the electrode of the fiber-kind of rechargeable battery by using the apparatus.

### 2. Description of the Related Art

A rechargeable battery is generally composed of an electrode assembly, and an electrolyte filled inside a fixed external package. In this case, a space may be specifically allocated to place the rechargeable battery inside an object that uses the rechargeable battery as a power source, which may result in restrictions on the degree of freedom.

The above information disclosed in this Background section is for enhancement of understanding of the background of the present disclosure, and therefore, it may contain information that does not constitute prior art.

### SUMMARY

In the case of a flexible rechargeable battery that may be deformable, such as, a fiber-kind of rechargeable battery, the rechargeable battery may be deformed and arranged to fit a remaining space of an object, so that a greater degree of freedom may be achieved in the design and production of the object. A fiber-kind of rechargeable battery may be composed of a bundle of fiber-kind of electrodes.

Embodiments of the present disclosure may be directed to an apparatus for manufacturing a fiber-kind of electrode, and a manufacturing method of the fiber-kind of electrode using the apparatus.

According to one or more embodiments of the present disclosure, a manufacturing apparatus of a fiber-kind of electrode, includes: a tank containing an active material solution and a polymer solution separated into a lower layer and an upper layer, and not mixed with each other; a transport portion configured to transport a fibrous substrate including: a supply roll located outside the tank; a take-up roll installed inside the tank to be immersed in the active material solution; and a winding roll located outside of the tank; a tubular portion surrounding around a part of the fibrous substrate transported between the supply roll and the take-up roll, and installed inside the tank to have an outer surface in contact with the polymer solution; and a dryer installed between the tank and the winding roll, and configured to dry the fibrous substrate discharged from the tank.

In an embodiment, the tubular portion may have a pipe shape having an interior space and opposite open ends, and the tubular portion may be installed inside the tank by a support.

In an embodiment, an upper end of the tubular portion may be located higher than a solution level of the polymer solution; and a lower end of the tubular portion may be located lower than a solution level of the active material solution.

In an embodiment, the tubular portion may be installed in the tank via a slider configured to be moved along a vertical direction, and a height of the tubular portion may be configured to be adjusted according to a change of a solution level of the active material solution.

In an embodiment, the manufacturing apparatus may further include: a sensor configured to detect the solution level of the active material solution; and a controller configured to control an operation of the slider by using a detection signal of the sensor.

In an embodiment, the transport portion may further include a transport roll located between the take-up roll and the winding roll; and the dryer may be located between the transport roll and the winding roll to dry the fibrous substrate having passed through the transport roll.

In an embodiment, the transport portion may further include a transport roll located between the take-up roll and the winding roll; and the dryer may be located between the take-up roll and the transport roll to dry the fibrous substrate discharged from the tank.

According to one or more embodiments of the present disclosure, a manufacturing method of a fiber-kind of electrode, includes: injecting an active material solution and a polymer solution into a tank; unwinding a fibrous substrate from a supply roll; transporting the fibrous substrate so that the fibrous substrate sequentially passes through the active material solution and the polymer solution inside the tank to coat an active material solution layer on a surface of the fibrous substrate, and to coat a polymer solution layer on a surface of the active material solution layer; and fabricating an active material layer and a separation layer by drying the active material solution layer and the polymer solution layer. The active material solution and the polymer solution are not mixed with each other inside the tank, and are separated into a lower layer and an upper layer by a density difference therebetween.

In an embodiment, a take-up roll immersed in the active material solution may be installed inside the tank; the fibrous substrate may move from the supply roll via the take-up roll; and a tubular portion may be installed inside the tank to surround around a part of the fibrous substrate moving from the supply roll toward the take-up roll.

In an embodiment, the tubular portion may have an outer surface in contact with the polymer solution so that the fibrous substrate proceeding through an interior of the tubular portion does not contact the polymer solution.

In an embodiment, an upper end of the tubular portion may be located higher than a solution level of the polymer solution, and a lower end of the tubular portion may be located lower than a solution level of the active material solution.

In an embodiment, the tubular portion may be installed in the tank via a slider that may be movable along a vertical direction, and the tubular portion may have a height adjusted according to a change of a solution level of the active material solution.

In an embodiment, a sensor installed outside the tank may detect the solution level of the active material solution; and a controller electrically connected to the sensor may control an operation of the slider by using a detection signal of the sensor.

In an embodiment, the fibrous substrate unwound from the supply roll may contact the active material solution when exiting the tubular portion, may change a moving direction through the take-up roll in the active material solution, and may pass through the polymer solution to exit the polymer solution.

In an embodiment, a transport roll and a winding roll may be located outside the tank; the fibrous substrate may move from the take-up roll via the transport roll to be wound around the winding roll; and a dryer may be located between the transport roll and the winding roll to dry the active material solution layer and the polymer solution layer on the surface of the fibrous substrate.

In an embodiment, a transport roll and a winding roll may be located outside the tank; the fibrous substrate may move from the take-up roll via the transport roll to be wound around the winding roll; and a dryer may be located between the take-up roll and the transport roll to dry the active material solution layer and the polymer solution layer on the surface of the fibrous substrate.

In an embodiment, the fibrous substrate may be a positive electrode substrate; the active material solution may be a positive active material solution; and the active material layer may be a positive active material layer.

In an embodiment, the fibrous substrate may be a negative electrode substrate; the active material solution may be a negative active material solution; and the active material layer may be a negative active material layer.

According to some embodiments of the present disclosure, both an active material solution and a polymer solution may be accommodated in a single tank, and an active material solution layer and a polymer solution layer may be sequentially coated on a surface of a fibrous substrate by using a tubular portion and a take-up roll. Accordingly, a configuration of a manufacturing apparatus may be simplified, a number of processes may be minimized or reduced, and a manufacturing efficiency of the fiber-kind of electrode may be improved (e.g., may be raised or increased).

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above information disclosed in this Background section is for enhancement of understanding of the background of the present disclosure, and therefore, it may contain information that does not constitute prior art.

FIG. 1 is a schematic diagram of a manufacturing apparatus of a fiber-kind of electrode according to a first embodiment.

FIG. 2 a schematic diagram of a manufacturing apparatus of a fiber-kind of electrode according to the first embodiment.

FIG. 3 is a schematic diagram of a fiber-kind of rechargeable battery.

FIG. 4 is a partial enlarged view of the fiber-kind of rechargeable battery of FIG. 3.

FIG. 5 is a cross-sectional view of a fiber-kind of rechargeable battery.

FIG. 6 a cross-sectional view of a fiber-kind of rechargeable battery.

FIG. 7 is a schematic diagram of a manufacturing apparatus of a fiber-kind of electrode according to a second embodiment.

FIG. 8 is a schematic diagram of a manufacturing apparatus of a fiber-kind of electrode according to a third embodiment.

FIG. 9 is a flowchart showing a manufacturing method of a fiber-kind of electrode according to an embodiment.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

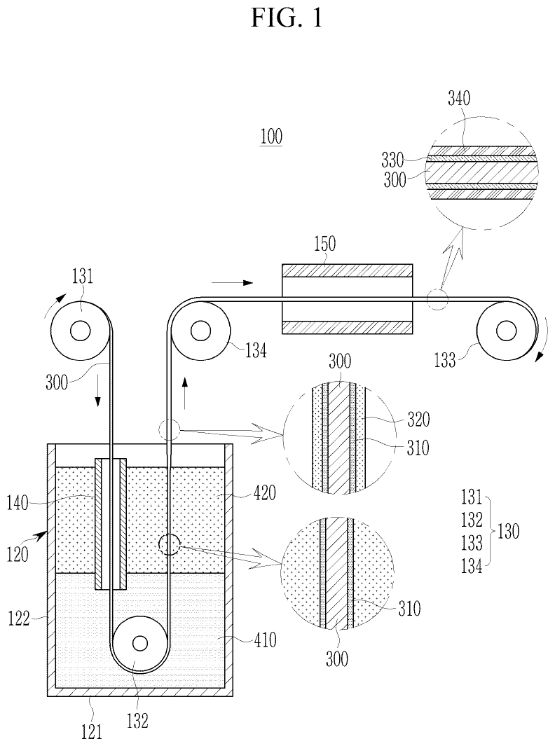

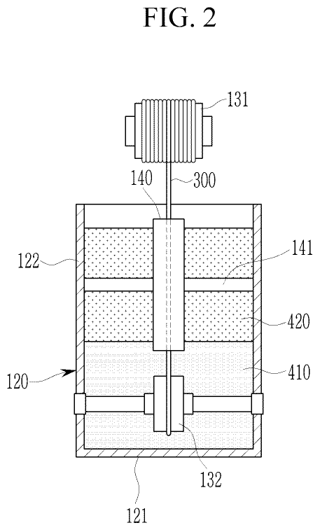

FIG. 1 is a schematic diagram of a manufacturing apparatus of a fiber-kind of electrode according to a first embodiment. FIG. 2 a schematic diagram of the manufacturing apparatus of a fiber-kind of electrode according to the first embodiment.

Referring to FIG. 1 and FIG. 2, a manufacturing apparatus of a fiber-kind of electrode (hereinafter, referred to as “the manufacturing apparatus” for convenience) 100 of the first embodiment may include a tank 120 for containing two kinds of solutions that are located to be separated into upper and lower layers, a transport portion 130 installed across an inside and an outside of the tank 120 to transport a fibrous substrate, a tubular portion 140 installed inside the tank 120 to have an outer surface that is in contact with a solution (e.g., a specific or predetermined kind of solution), and a dryer 150 located outside the tank 120.

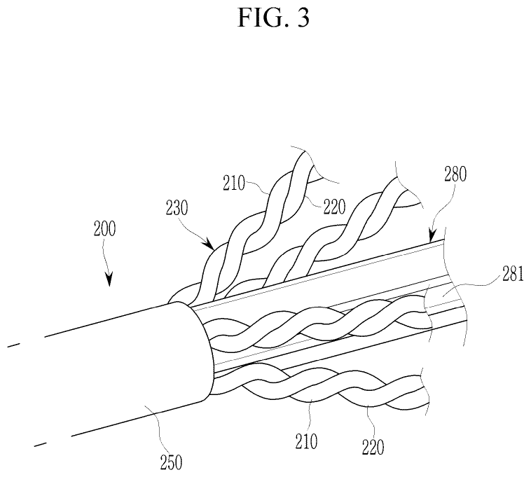

The manufacturing apparatus 100 will be described in more detail below, and a fiber-kind of rechargeable battery will be briefly described first with reference to FIGS. 3 to 6.

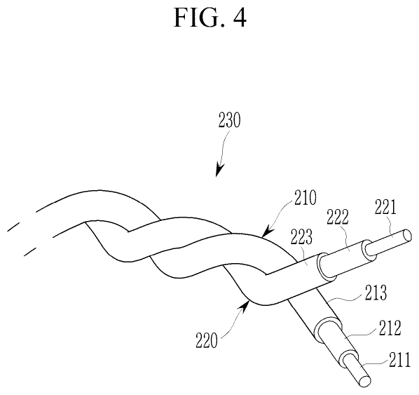

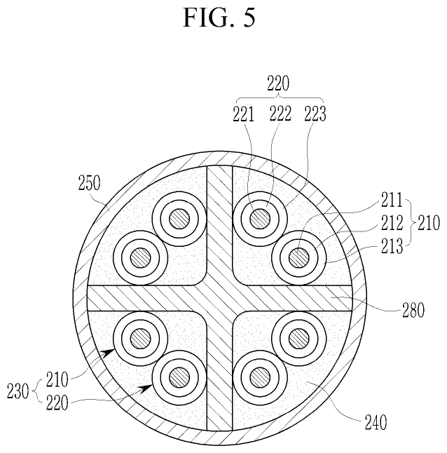

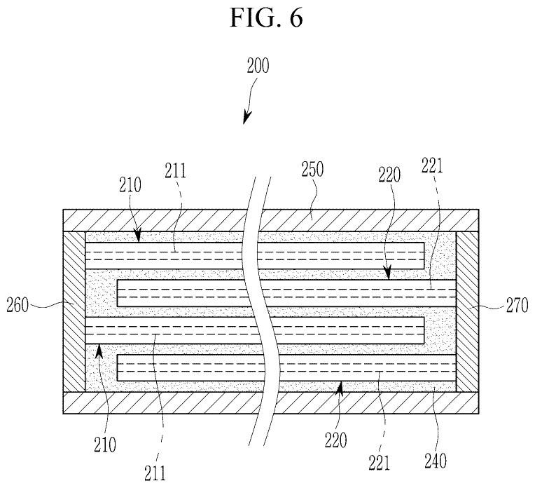

FIG. 3 is a schematic diagram of the fiber-kind of rechargeable battery. FIG. 4 is a partial enlarged view of the fiber-kind of rechargeable battery of FIG. 3. FIG. 5 is a cross-sectional view of the fiber-kind of rechargeable battery. FIG. 6 is a cross-sectional view of the fiber-kind of rechargeable battery. However, the present disclosure is not limited to the fiber-kind of rechargeable battery shown in FIG. 3 to FIG. 6, and the fiber-kind of rechargeable battery may be variously modified as needed or desired.

Referring to FIG. 3 to FIG. 6, a fiber-kind of rechargeable battery 200 may include a plurality of fiber-kind of electrodes 230, a protective layer 250 surrounding (e.g., around peripheries of) the plurality of fiber-kind of electrodes 230 together with an electrolyte 240, a positive electrode cap 260 located at (e.g., in or on) one end portion of the protective layer 250, and a negative electrode cap 270 located at (e.g., in or on) an opposite end portion of the protective layer 250. The fiber-kind of electrode 230 may include at least one positive electrode fiber 210 and at least one negative electrode fiber 220.

The positive electrode fiber 210 may include a thread-shaped positive electrode substrate 211, a positive active material layer 212 surrounding (e.g., around a periphery of) the positive electrode substrate 211, and a separation layer 213 surrounding (e.g., around a periphery of) the positive active material layer 212. The negative electrode fiber 220 may include a thread-shaped negative electrode substrate 221, a negative active material layer 222 surrounding (e.g., around a periphery of) the negative electrode substrate 221, and a separation layer 223 surrounding (e.g., around a periphery of) the negative active material layer 222. The positive electrode substrate 211 may be referred to as a positive current collector, and the negative electrode substrate 221 may be referred to as a negative current collector.

The at least one positive electrode fiber 210 and the at least one negative electrode fiber 220 may be twisted together to form a twisted pair. FIG. 3 illustrates an example in which the plurality of fiber-kind of electrodes 230 are configured as four twisted pairs. The separation layers 213 and 223 of the positive electrode fiber 210 and the negative electrode fiber 220 may physically separate the positive active material layer 212 and the negative active material layer 222, respectively, and may contain the electrolyte 240 within micropores therein.

The protective layer 250, which may be an external cladding layer of the fiber-kind of rechargeable battery 200, may be made of a polymer resin, and may have a property of being easily bent. The electrolyte 240 may exist in any one of a liquid-state, a solid-phase, or a gel-state.

The positive electrode cap 260 and the negative electrode cap 270 may seal both side end portions (e.g., opposite side end portions) of the protective layer 250 to prevent or substantially prevent the electrolyte 240 from leaking. The positive electrode cap 260 may be coupled to a plurality of positive electrode substrates 211, to function as a positive electrode terminal. The negative electrode cap 270 may be coupled to a plurality of negative electrode substrates 221, to function as a negative electrode terminal.

The fiber-kind of rechargeable battery 200 may further include a pillar 280 functioning as a cell barrier. The pillar 280 may be located at a center inside the protective layer 250, and may be provided with a number of groove portions 281 corresponding to a plurality of twisted pairs. The plurality of twisted pairs may be located one by one in the groove portions 281 of the pillar 280. The pillar 280 may be made of a polymer resin, and may have a property of being easily bent.

Referring back to FIG. 1 and FIG. 2, the manufacturing apparatus 100 of the first embodiment may be an apparatus for manufacturing a fiber-kind of electrode used in the fiber-kind of rechargeable battery. Depending on the material of a fibrous substrate 300 transported by the transport portion 130, and the composition of the solution contained in the tank 120, either one of the positive electrode fiber 210 (e.g., see FIG. 4) or the negative electrode fiber 220 may be manufactured. The fibrous substrate 300 may refer to the positive electrode substrate or the negative electrode substrate.

The tank 120 may be configured as a container having an open top. For example, the tank 120 may include a bottom portion 121, and a side portion 122 connected to an edge of the bottom portion 121. The side portion 122 may be formed of various suitable shapes, such as a rectangle or a circle.

Two kinds of solutions may be contained in the tank 120. The two kinds of solutions may be separated into upper and lower layers without mixing due to a density difference therebetween. A solution forming the lower layer may be an active material solution 410 for forming the active material layer. A solution forming the upper layer may be a polymer solution 420 for forming the separation layer. The tank 120 may be manufactured with a transparent material so that a worker may confirm a boundary between the active material solution 410 and the polymer solution 420.

The active material solution 410 may be in a slurry state, which is a semiliquid mixture, and may have a density higher than a density of the polymer solution 420. Due to the higher density, the active material solution 410 may be located below the polymer solution 420 in a state of being separated from the polymer solution 420. The active material solution 410 may be a positive active material solution, or a negative active material solution.

The transport portion 130 may generally include a supply roll 131 located on an outer side of the tank 120, a take-up roll 132 installed inside the tank 120 to be immersed in the active material solution 410, and a winding roll 133 located outside of the tank 120. The transport portion 130 may transport the fibrous substrate 300 in a uniform or substantially uniform speed from the supply roll 131 to the winding roll 133 via the take-up roll 132. The transport portion 130 may further include at least one transport roll 134 to change a moving direction of the fibrous substrate 300.

The supply roll 131 winds the fibrous substrate 300, and may unwind the fibrous substrate 300 at a constant or substantially constant speed. When the supply roll 131 is disposed directly above the tank 120, a transport roll may be omitted between the supply roll 131 and the take-up roll 132.

The take-up roll 132 may be installed inside the tank 120 to be immersed in the active material solution 410. For example, the take-up roll 132 may be located to be closer to the bottom portion 121 than an upper end of the side portion 122, and an uppermost end of the take-up roll 132 may be located to be lower than a solution level of the active material solution 410 set in the manufacturing process.

The take-up roll 132 may be rotatably combined with the side portion 122 by using a rotation shaft, a bearing, or the like. The take-up roll 132 may rotate by a power for winding the winding roll 133 and the fibrous substrate 300, or may rotate by using its own driving means, such as a motor. The fibrous substrate 300 unwound from the supply roll 131 may be wound around the winding roll 133 via the take-up roll 132. The take-up roll 132 may change the moving direction of the fibrous substrate 300 by approximately 180°.

The transport roll 134 may be located between the take-up roll 132 and the winding roll 133 along the moving direction of the fibrous substrate 300. The transport roll 134 may be located on an upper side of the tank 120, and may change the moving direction of the fibrous substrate 300 by approximately 90°. The winding roll 133 may rotate by being provided with its own driving means, such as a motor, and may wind the fibrous substrate 300.

The tubular portion 140 may be a cylindrical pipe having an empty interior (e.g., an inner space or channel), and both (e.g., opposite) open ends. The tubular portion 140 may be installed in the tank 120 by a support 141, and may surround (e.g., around a periphery of) the fibrous substrate 300 inside the tank 120 to function as a driving passage of the fibrous substrate 300. The tubular portion 140 may be located to surround (e.g., around a periphery of) a part of the fibrous substrate 300 proceeding from the supply roll 131 toward the take-up roll 132, and may be installed to have an outer surface that is in contact with the polymer solution 420 forming the upper layer.

The fibrous substrate 300 that is unwound from the supply roll 131 may move downward toward the take-up roll 132, and the tubular portion 140 may be installed inside the tank 120 in a vertical direction in parallel or substantially in parallel to the fibrous substrate 300. In this case, the vertical direction may be parallel to or substantially parallel to a gravitational direction. An upper end of the tubular portion 140 may be located higher than a solution level of the polymer solution 420. A lower end of the tubular portion 140 may be located lower than the solution level of the active material solution 410.

The tubular portion 140 may prevent the fibrous substrate 300 proceeding from the supply roll 131 toward the take-up roll 132 from first contacting the polymer solution 420. In other words, the fibrous substrate 300 that is unwound from the supply roll 131 may not contact the polymer solution 420 during the process of passing through the interior of the tubular portion 140, and may contact the active material solution 410 at a time of exiting the lower end of the tubular portion 140.

Due to the contact between the fibrous substrate 300 and the active material solution 410, an active material solution layer 310 may be primarily coated to a desired thickness (e.g., a predetermined thickness) on a surface of the fibrous substrate 300. The fibrous substrate 300 may move upward by changing the direction by 180° while passing through the take-up roll 132, and may enter the polymer solution 420. Due to a contact between the active material solution layer 310 and the polymer solution 420, a polymer solution layer 320 may be secondarily coated to a desired thickness (e.g., a predetermined thickness) on a surface of the active material solution layer 310.

The active material solution layer 310 and the polymer solution layer 320 may be sequentially coated on the surface of the fibrous substrate 300 having exited the polymer solution 420. In this case, both of the active material solution layer 310 and the polymer solution layer 320 may be a liquid, but they may maintain or substantially maintain a state of being not mixed with each other, and may be separated from each other due to the density difference therebetween.

A thickness of the active material solution layer 310 and a thickness of the polymer solution layer 320 may vary according to the moving speed of the fibrous substrate 300. For example, the moving speed of the fibrous substrate 300 may be proportional to a rotation speed of the winding roll 133. By adjusting the rotation speed of the winding roll 133, the thickness of the active material solution layer 310 and the polymer solution layer 320 may be controlled (e.g., may be precisely controlled).

The dryer 150 may be located between the transport roll 134 and the winding roll 133, and the active material solution layer 310 and the polymer solution layer 320 may be heated for drying or curing. The active material solution layer 310 may become an active material layer 330 by being solidified by the drying, and the polymer solution layer 320 may become a separation layer 340 by being solidified by the drying. The active material layer 330 may refer to the positive active material layer or the negative active material layer. The separation layer 340 may refer to the separation layer of the positive electrode fiber, or the separation layer of the negative electrode fiber.

Although one dryer 150 is illustrated in the drawings as an example, a plurality of dryers may be installed in parallel with each other along a transport direction of the fibrous substrate 300. The plurality of dryers may have at least one difference in a heating temperature and a drying method from each other. The fibrous substrate 300 may become the fiber-kind of electrode by obtaining the active material layer 330 and the separation layer 340 after having passed through the dryer 150, and a completed fiber-kind of electrode may be wound around the winding roll 133.

The manufacturing apparatus 100 described above may sequentially form the active material layer 330 and the separation layer 340 on the surface of the fibrous substrate 300 with a simplified mechanical configuration (e.g., a single tank 120, the tubular portion 140, and the transport portion 130 having a minimized or reduced number of rolls), and thereby, may manufacture the fiber-kind of electrode with a higher efficiency.

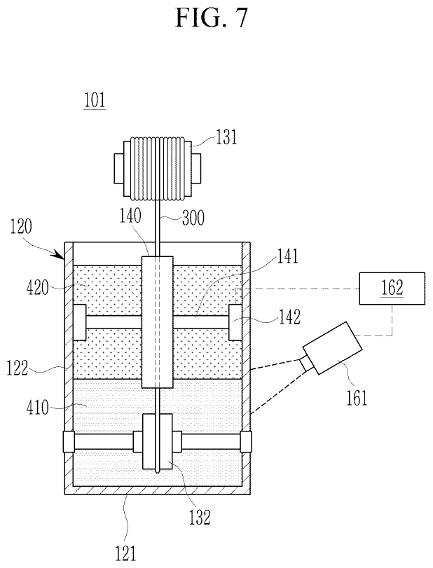

FIG. 7 is a schematic diagram of a manufacturing apparatus of a fiber-kind of electrode according to a second embodiment.

Referring to FIG. 7, in a manufacturing apparatus 101 of the second embodiment, the tubular portion 140 may be height adjustable (e.g., may be capable of lifting and lowering).

As coating progresses, the solution level of the active material solution 410 and the solution level of the polymer solution 420 may gradually decrease. When the active material solution 410 and the polymer solution 420 are not continuously replenished, the fibrous substrate 300 having exited the tubular portion 140 may contact the polymer solution 420.

In the manufacturing apparatus 101 of the second embodiment, the height of the tubular portion 140 may be adjusted according to a change of the solution level of the active material solution 410. For example, the tubular portion 140 may be installed in the tank 120 via a slider 142 that is movable along the vertical direction. The slider 142 may be configured as a manual slider that may move by a user's operation, or an automatic slider that may move by an external power.

In the case of the automatic slider, the manufacturing apparatus 101 may further include a sensor 161 to detect the solution level of the active material solution 410, and a control unit (e.g., a controller) 162 to control a driver of the slider 142 by using a detection signal of the sensor 161. The control unit 162 may control the driver of the slider 142 according to a change of the solution level of the active material solution 410 detected by the sensor 161, to adjust the height of the tubular portion 140.

Even when the solution level of the active material solution 410 is lowered, the manufacturing apparatus 101 of the second embodiment may prevent the fibrous substrate 300 having exited the tubular portion 140 from contacting the polymer solution 420, and a manufacturing defect of the fiber-kind of electrode may be prevented or substantially prevented. The manufacturing apparatus 101 of the second embodiment may be the same or substantially the same as (or similar to) the first embodiment described above, except for the height adjustment structure of the tubular portion 140, and thus, redundant description thereof will not be repeated.

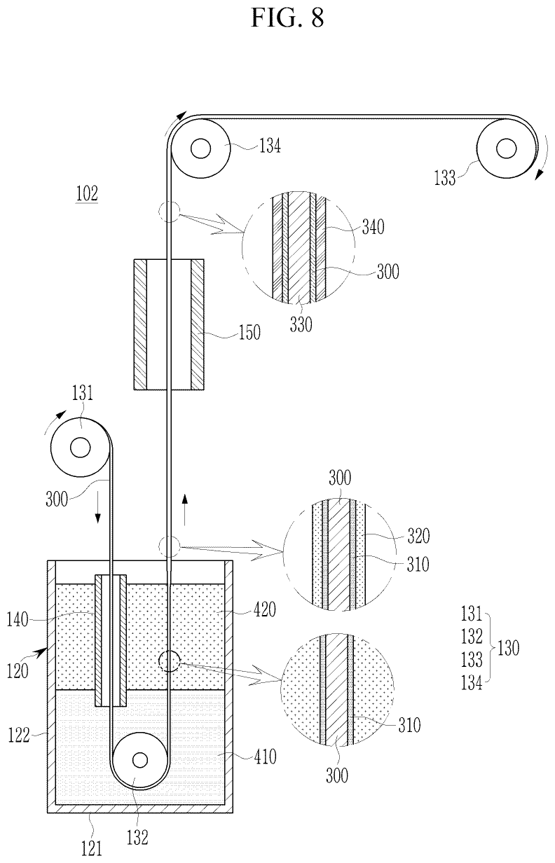

FIG. 8 is a schematic diagram of a manufacturing apparatus of a fiber-kind of electrode according to a third embodiment.

Referring to FIG. 8, in a manufacturing apparatus 102 of the third embodiment, the dryer 150 may be located between the take-up roll 132 and the transport roll 134, and may heat the active material solution layer 310 and the polymer solution layer 320 having immediately exited the polymer solution 420 for drying or curing.

Although one dryer 150 is illustrated in the drawings as an example, a plurality of dryers may be installed in parallel with each other along the transport direction of the fibrous substrate 300. The plurality of dryers may be configured to have at least one difference in a heating temperature and a drying method from each other.

According to the manufacturing apparatus 102 of the third embodiment, the active material solution layer 310 and the polymer solution layer 320 may be solidified before contacting another component, and thus, a quality of the fiber-kind of electrode may be increased (e.g., may be improved). The manufacturing apparatus 102 of the third embodiment may be the same or substantially the same as) or similar to) one of the first embodiment or the second embodiment described above, except for the location of the dryer 150, and thus, redundant description thereof will not be repeated.

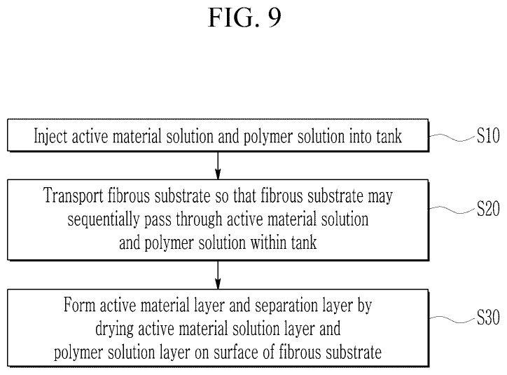

FIG. 9 is a flowchart showing a manufacturing method of a fiber-kind of electrode according to an embodiment.

Referring to FIG. 9, a manufacturing method of a fiber-kind of electrode according to an embodiment may include injecting the active material solution and the polymer solution into a tank (S10), and transporting the fibrous substrate so that the fibrous substrate may sequentially pass through the active material solution and the polymer solution within the tank (S20). For example, the fibrous substrate may be unwound from the supply roll to be transported to the tank.

At S20, the active material solution layer may be coated on the surface of the fibrous substrate, and the polymer solution layer may be coated on the surface of the active material solution layer. The manufacturing method of a fiber-kind of electrode according to an embodiment may further include forming the active material layer and the separation layer by drying the active material solution layer and the polymer solution layer on the surface of the fibrous substrate (S30), for example, by using a dryer.

Referring to FIG. 1 to FIG. 9, when forming the positive electrode fiber 210, at S10, the active material solution 410 may be the positive active material solution, and at S20, the fibrous substrate 300 may be the positive electrode substrate 211. When forming the negative electrode fiber 220, the active material solution 410 may be the negative active material solution at S10, and the fibrous substrate 300 may be the negative electrode substrate 221 at S20.

The positive electrode substrate 211 may be configured as, for example, an aluminum wire. The negative electrode substrate 221 may be configured as, for example, a copper wire or a nickel wire.

The positive active material solution may include a positive active material and a solvent, and may further include a binder and/or a conductive material. The positive active material may include a lithium transition metal complex oxide. The lithium transition metal composite oxide may include, for example, at least one of a lithium-nickel-based oxide, a lithium-cobalt-based oxide, a lithium-manganese-based oxide, a lithium-iron phosphate-based compound, or a cobalt-free lithium nickel-manganese-based oxide. The solvent may be an organic solvent that contains, for example, N-Methyl-2-pyrrolidone (NMP) or the like, or an aqueous solvent containing water.

The negative active material solution may include a negative active material and a solvent, and may further include a binder and/or a conductive material. The negative active material may include at least one of a carbon-based active material or a silicon-based active material. The carbon-based active material may include at least one of a natural graphite or an artificial graphite. The silicon-based active material may include at least one of a silicon-carbon composite active material, silicon oxide (SiOx, 0<x≤2), or silicon carbide (SiC). The solvent may be, for example, an aqueous solvent containing water.

The polymer solution 420 may include a polymer material and a solvent. The polymer material may include, for example, one or more of polyethylene, polypropylene, polyethylene terephthalate, polypropylene terephthalate, polybutylene terephthalate, polyester, polycarbonate, and/or polyimide. The solvent be an organic solvent that includes, for example, dichloromethane or the like.

The positive active material solution and the negative active material solution may be in a slurry state having a high viscosity. The polymer solution 420 may be a liquid having lower viscosity than those of the positive active material solution and the negative active material solution. A density of the active material solution 410 may be higher than a density of the polymer solution. When the active material solution 410 and the polymer solution 420 are inserted into the tank 120 at S10, due to a density difference therebetween, the active material solution 410 and the polymer solution 420 may not be mixed with each other, and may be separated into an upper layer and a lower layer.

For example, the density of the positive active material solution may be approximately 1.4 g/ml to 2.5 g/ml, and the density of the negative active material solution may be approximately 1.2 g/ml to 1.4 g/ml. The density of the polymer solution 420 may be approximately 1 g/ml to 1.17 g/ml.

At S20, the transport portion 130 may transport the fibrous substrate 300 in a uniform or substantially uniform speed. The transport portion 130 may include the supply roll 131 to unwind the fibrous substrate 300, the winding roll 133 to wind the fibrous substrate 300, the take-up roll 132 installed inside the tank 120 to be immersed into the active material solution 410, and the at least one transport roll 134.

In addition, the tubular portion 140 surrounding (e.g., around a periphery of) a part of the fibrous substrate 300 proceeding from the supply roll 131 toward the take-up roll 132 may be installed inside the tank 120. The tubular portion 140 may be located to have its outer surface to be in contact with the polymer solution 420.

At S20, the fibrous substrate 300 may be unwound from the supply roll 131 to move downward toward the take-up roll 132, and while passing through the tubular portion 140, the contact with the polymer solution 420 may be blocked by the tubular portion 140. The fibrous substrate 300 may contact the active material solution 410 when exiting the tubular portion 140, and due to the contact between the fibrous substrate 300 and the active material solution 410, the active material solution layer 310 may be coated on the surface of the fibrous substrate 300.

Subsequently, the fibrous substrate 300 may move upward by changing a direction by 180° by the take-up roll 132, and may pass through the polymer solution 420. Due to a contact between the active material solution layer 310 and the polymer solution 420, the polymer solution layer 320 may be coated on the surface of the active material solution layer 310. Although the active material solution layer 310 and the polymer solution layer 320 may be liquids, but due to a density difference therebetween, they may not be mixed with each other and may maintain a separated state from each other.

At S30, a dryer 140 may heat the active material solution layer 310 and the polymer solution layer 320 to dry or cure them. The active material solution layer 310 may become the active material layer 330 by being solidified by the drying, and the polymer solution layer 320 may become the separation layer 340 by being solidified by the drying.

Either one of the positive electrode fiber 210 or the negative electrode fiber 220 may be completed through above-described processes, and the positive electrode fiber 210 or the negative electrode fiber 220 that have been completed may be unwound around the winding roll 133.

In a comparative dip coating method, one solution is stored in a single tank. Accordingly, in order to sequentially form two coating layers, the active material solution and the polymer solution are separately contained in two tanks, and the number of the transport rolls constituting the transport portion is increased, so that the fibrous substrate may sequentially pass through an inside of a plurality of tanks. In this case, the configuration of the manufacturing apparatus may be more complicated, the number of processes may be increased, and it may take a longer time to manufacture the fiber-kind of electrode.

In the manufacturing method according to an embodiment, both of the active material solution 410 and the polymer solution 420 may be contained in the single tank 120, and by using the tubular portion 140, the active material solution layer 310 may be first coated on the surface of the fibrous substrate 300. According to a manufacturing method of an embodiment, the configuration of the manufacturing apparatus may be simplified, the number of processes may be minimized or reduced, and the manufacturing efficiency of the fiber-kind of electrode may be increased.

Referring to FIG. 7 and FIG. 9, as coating progresses at S20, the solution level of the active material solution 410 and the solution level of the polymer solution 420 may be lowered. The tubular portion 140 may be installed in the tank 120 via the slider 142 that is movable along the vertical direction, and the sensor 161 may detect the solution level of the active material solution 410. The driver of the slider 142 and the sensor 161 may be electrically connected to the control unit 162.

During the process of performing the coating, the sensor 161 may detect the solution level of the active material solution 410, and the control unit 162 may control an operation of the slider 142 by using the detection signal of the sensor 161. For example, as the solution level of the active material solution 410 is lowered, the control unit 162 may move the slider 142 downward to lower a height of the tubular portion 140.

Referring to FIG. 1 to FIG. 9, at S30, the dryer 150 may be installed between the transport roll 134 and the winding roll 133, and may dry the active material solution layer 310 and the polymer solution layer 320 having passed through the transport roll 134 (e.g., see FIG. 1). As another example, at S30, the dryer 150 may be installed between the take-up roll 132 and the transport roll 134, and may dry the active material solution layer 310 and the polymer solution layer 320 having immediately exited the polymer solution 420 (e.g., see FIG. 8).

Referring to FIG. 3 to FIG. 6, the positive electrode fiber 210 and the negative electrode fiber 220 may configure a twisted pair, and the plurality of twisted pairs and the electrolyte 240 may be surrounded (e.g., around peripheries thereof) by the protective layer 250, thereby forming the fiber-kind of rechargeable battery 200. Two or more fiber-kind of rechargeable batteries may be twisted together to form a thicker rechargeable battery cable, or a plurality of fiber-kind of rechargeable batteries may be woven together as warp and weft yarns to form a rechargeable battery fabric.

The internal temperature and internal pressure of the fiber-kind of rechargeable battery 200 may rapidly increase due to various causes, such as rapid charging and discharging, external impacts, and exposure to high temperature environments. In this case, the pillar 280 inside the protective layer 250 physically separates the plurality of twisted pairs, thereby preventing or substantially preventing a sudden destruction, such as a fire or an explosion, of the fiber-kind of rechargeable battery 200.

The fiber-kind of rechargeable battery 200 may be easily deformed by an external force, and may be deformed into various suitable shapes. Accordingly, without specifically allocating a space for arranging the fiber-kind of rechargeable battery 200 inside an object that uses the fiber-kind of rechargeable battery 200 as a power source, the fiber-kind of rechargeable battery 200 may be deformed and arranged to fit a remaining space, and accordingly, a greater degree of freedom may be achieved in the design and the production of the object.

The electronic or electric devices and/or any other relevant devices or components according to embodiments of the present disclosure described herein (e.g., the control unit and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A manufacturing apparatus of a fiber-kind of electrode, comprising:
a tank containing an active material solution and a polymer solution separated into a lower layer and an upper layer, and not mixed with each other;
a transport portion configured to transport a fibrous substrate, comprising:
a supply roll located outside the tank;
a take-up roll installed inside the tank to be immersed in the active material solution; and
a winding roll located outside of the tank;
a tubular portion surrounding around a part of the fibrous substrate transported between the supply roll and the take-up roll, and installed inside the tank to have an outer surface in contact with the polymer solution; and
a dryer installed between the tank and the winding roll, and configured to dry the fibrous substrate discharged from the tank.

2. The manufacturing apparatus of claim 1, wherein the tubular portion has a pipe shape having an interior space and opposite open ends, and
wherein the tubular portion is installed inside the tank by a support.

3. The manufacturing apparatus of claim 2, wherein:
an upper end of the tubular portion is located higher than a solution level of the polymer solution; and
a lower end of the tubular portion is located lower than a solution level of the active material solution.

4. The manufacturing apparatus of claim 2, wherein the tubular portion is installed in the tank via a slider configured to be moved along a vertical direction, and
wherein a height of the tubular portion is configured to be adjusted according to a change of a solution level of the active material solution.

5. The manufacturing apparatus of claim 4, further comprising:
a sensor configured to detect the solution level of the active material solution; and
a controller configured to control an operation of the slider by using a detection signal of the sensor.

6. The manufacturing apparatus of claim 1, wherein:
the transport portion further comprises a transport roll located between the take-up roll and the winding roll; and
the dryer is located between the transport roll and the winding roll to dry the fibrous substrate having passed through the transport roll.

7. The manufacturing apparatus of claim 1, wherein:
the transport portion further comprises a transport roll located between the take-up roll and the winding roll; and
the dryer is located between the take-up roll and the transport roll to dry the fibrous substrate discharged from the tank.

8. A manufacturing method of a fiber-kind of electrode, comprising:
injecting an active material solution and a polymer solution into a tank;
unwinding a fibrous substrate from a supply roll;
transporting the fibrous substrate so that the fibrous substrate sequentially passes through the active material solution and the polymer solution inside the tank to coat an active material solution layer on a surface of the fibrous substrate, and to coat a polymer solution layer on a surface of the active material solution layer; and
fabricating an active material layer and a separation layer by drying the active material solution layer and the polymer solution layer,
wherein the active material solution and the polymer solution are not mixed with each other inside the tank, and are separated into a lower layer and an upper layer by a density difference therebetween.

9. The manufacturing method of claim 8, wherein:
a take-up roll immersed in the active material solution is installed inside the tank;
the fibrous substrate moves from the supply roll via the take-up roll; and
a tubular portion is installed inside the tank to surround around a part of the fibrous substrate moving from the supply roll toward the take-up roll.

10. The manufacturing method of claim 9, wherein the tubular portion has an outer surface in contact with the polymer solution so that the fibrous substrate proceeding through an interior of the tubular portion does not contact the polymer solution.

11. The manufacturing method of claim 10, wherein an upper end of the tubular portion is located higher than a solution level of the polymer solution, and a lower end of the tubular portion is located lower than a solution level of the active material solution.

12. The manufacturing method of claim 10, wherein the tubular portion is installed in the tank via a slider that is movable along a vertical direction, and the tubular portion has a height adjusted according to a change of a solution level of the active material solution.

13. The manufacturing method of claim 12, wherein:
a sensor installed outside the tank detects the solution level of the active material solution; and
a controller electrically connected to the sensor controls an operation of the slider by using a detection signal of the sensor.

14. The manufacturing method of claim 10, wherein the fibrous substrate unwound from the supply roll contacts the active material solution when exiting the tubular portion, changes a moving direction through the take-up roll in the active material solution, and passes through the polymer solution to exit the polymer solution.

15. The manufacturing method of claim 14, wherein:
a transport roll and a winding roll are located outside the tank;
the fibrous substrate moves from the take-up roll via the transport roll to be wound around the winding roll; and
a dryer is located between the transport roll and the winding roll to dry the active material solution layer and the polymer solution layer on the surface of the fibrous substrate.

16. The manufacturing method of claim 14, wherein:
a transport roll and a winding roll is located outside the tank;
the fibrous substrate moves from the take-up roll via the transport roll to be wound around the winding roll; and
a dryer is located between the take-up roll and the transport roll to dry the active material solution layer and the polymer solution layer on the surface of the fibrous substrate.

17. The manufacturing method of claim 8, wherein:
the fibrous substrate is a positive electrode substrate;
the active material solution is a positive active material solution; and
the active material layer is a positive active material layer.

18. The manufacturing method of claim 8, wherein:
the fibrous substrate is a negative electrode substrate;
the active material solution is a negative active material solution; and
the active material layer is a negative active material layer.
